(19) United States
(12) Patent Application Publication
(10) Pub. No.: US 2008/0114631 A1
(43) Pub. Date: May 15, 2008

(54) SERVICE EVALUATION SYSTEM, SERVICE EVALUATION METHOD, RECORDING MEDIUM STORING SERVICE EVALUATION PROGRAM

(75) Inventors: Yasuhide Matsumoto, Kawasaki (JP); Masatomo Yasaki, Kawasaki (JP); Masashi Uyama, Kawasaki (JP); Satoru Watanabe, Kawasaki (JP); Hiroki Ichiki, Kawasaki (JP); Mitsuru Oda, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/932,513

(22) Filed: Oct. 31, 2007

(30) Foreign Application Priority Data
Nov. 10, 2006 (JP) 2006-305252

(51) Int. Cl. G06Q 10/00; G06F 17/30; G06F 17/40

(52) U.S. Cl. 705/7

(57) ABSTRACT

A service evaluation system that evaluates a service in an IT system providing the service to a service user using an IT resource operated by a service operator includes a log acquisition part that acquires log data of the IT resource from a log data storage part, an interpretation data storage part that stores interpretation condition data representing a standard for interpreting the log data and interpretation result data representing a use state of the service by the service user, associated with the interpretation condition data, and a log evaluation part that extracts and outputs the interpretation result data stored in the interpretation data storage part, when the log data acquired by the log acquisition part satisfies the standard represented by the interpretation condition data.

### BACKGROUND OF THE INVENTION

1. Field of the Invention

The present invention relates to a service evaluation system, a service evaluation method, and a recording medium storing a service evaluation program. More specifically, the present invention relates to a service evaluation system, a service evaluation method, and a recording medium storing a service evaluation program for evaluating a service in an IT system that provides the service to service users, using IT resources operated by a service operator.

2. Description of Related Art

Recently, along with the spread of the Internet, an e-commerce organizer that makes a contract and a payment using the Internet, for example, as in a net bank, is increasing in number. When such an e-commerce organizer manages a site with its own server, the e-commerce organizer needs to keep a setting space involved in an increase in servers along with the enlargement of the site. Furthermore, the e-commerce organizer needs to set a facility for operating a server stably, take measures against disasters such as an earthquake and a fire, take security measures, and the like. Therefore, when the e-commerce organizer manages a site with its own server, there is a problem that a cost is incurred.

In order to solve such a problem, recently, a facility called an Internet Data Center (hereinafter, referred to as an “IDC”) is spreading. The IDC is a facility that lends IT resources such as a server, a storage, and a network operated by an IDC organizer to, for example, an e-commerce organizer, thereby providing a connection line to the Internet, a maintenance/operation service, and the like. Therefore, the e-commerce organizer can reduce a cost by using a setting space for IT resources, a stable power source supply facility, an air-conditioning facility, a disaster prevention facility, a strict access management facility, and the like provided by the IDC, compared with the case of arranging them by itself.

FIG. 17 is a conceptual diagram showing a system configuration of a general IDC. As shown in FIG. 17, an IDC 100 includes an IT system 101. The IT system 101 further includes IT resources 101a to 101d. A service operator (IDS organizer) extracts IT resources provided in the IT system 101, and lends the extracted IT resources to, for example, a service provider such as an e-commerce organizer, using an operator terminal 102. The service provider downloads software to the lent IT resources, using a provider terminal 103, thereby providing various services S to service users. The service users use the services S provided by the service provider via the Internet, using user terminals 104.

As an example of the services S provided to the service users by the service provider, there is a Software as a Service (SaaS) type service. The SaaS refers to the provision of software as a service. According to the SaaS-type service, the services S are provided by the function unit of software, so that the service users can use a minimum required amount of the services S for each application. Therefore, in the SaaS-type service, the service users are likely to switch to a service provider that provides better services S. Consequently, a service provider always needs to care about whether or not the services S provided by the service provider satisfy the demands of the service users.

Specifically, for example, the service provider acquires log data on the IT resources 101a to 101d from the IT system 101. The service provider analyzes the acquired log data, and statistically determines whether the IT resources 101a to 101d are in a shortage or surplus state (for example, see JP 2004-5233 A or JP 2006-99426 A).

When the service provider determines that the IT resources 101a to 101d are in a shortage state, the service provider requests a service operator to increase the IT resources 101a to 101d. On the other hand, when the service provider determines that the IT resources 101a to 101d are in a surplus state, the service provider requests the service operator to decrease the IT resources 101a to 101d. The service operator increases/decreases the IT resources 101a to 101d with respect to the IT system 101, based on a request from the service provider. Thus, the service provider can provide the services S that satisfy the requests by the service users with respect to the performance of the IT resources 101a to 101d.

However, according to the above-mentioned conventional method, the service operator performs only increase/decrease in IT resources with respect to the IT system, i.e., so-called resource management, based on a request from the service provider. Furthermore, in the above-mentioned conventional IDC, data that represents the use state of services by the service users is not presented to the service operator.

Therefore, it is difficult for the service operator to obtain information (hereinafter, referred to as “improvement points of services”) for improving the services used by the service users. This makes it impossible for the service operator to propose improvement points of services with respect to the service provider.

### SUMMARY OF THE INVENTION

The present invention has been achieved in view of the above problems, and its object is to provide a service evaluation system, a service evaluation method, and a recording medium storing a service evaluation program, capable of obtaining improvement points of services used by service users in a service operator.

In order to achieve the above object, a service evaluation system according to the present invention evaluates a service in an IT system providing the service to a service user using an IT resource operated by a service operator, and includes a log acquisition part that acquires log data of the IT resource from a log data storage part storing the log data, an interpretation data storage part that stores interpretation condition data representing a standard for interpreting the log data and interpretation result data representing a use state of the service by the service user, associated with the interpretation condition data, and a log evaluation part that extracts and outputs the interpretation result data stored in the interpretation data storage part, when the log data acquired by the log acquisition part satisfies the standard represented by the interpretation condition data.

According to the service evaluation system of the present invention, the log evaluation part can extract interpretation result data stored in the interpretation data storage part, when the log data acquired by the log acquisition part satisfies the standard represented by the interpretation condition data. The interpretation result data represents the use state of the service by the service user. Furthermore, the log evaluation part outputs the extracted interpretation result data, so that the service operator can obtain an improvement point of the service from the use state of the service by the service user. Therefore, the service operator can propose to, for example, a service provider providing the service using the IT resource, an improvement point of the service.

The log evaluation part may output interpretation result data to a storage part or a recording medium (a DVD, a CD, a flexible disk, a magnetic tape, etc.), and may output interpretation result data to a display part. Furthermore, the log evaluation part may output interpretation result data to a printing apparatus such as a printer.

Furthermore, the “IT resource” is at least one of hardware and software constituting the IT system. Examples of the IT resource include a server, middleware, a network, a storage, various kinds of terminals (a personal computer, a PDA, a mobile telephone, etc.), and a radio frequency identification (RFID) tag.

In the above-mentioned service evaluation system according to the present invention, it is preferred that the interpretation result data represents a progress state with respect to the service user in the service used by the service user, and the service evaluation system further includes a period data storage part that stores provision period data representing a period during which the service is provided to the service user or schedule period data representing a schedule period of the service user, and a service evaluation part that compares the interpretation result data extracted by the log evaluation part with the provision period data or the schedule period data stored in the period data storage part to generate period improvement data representing an improvement point regarding the period of the service used by the service user.

According to the above configuration, the service evaluation part compares the interpretation result data representing the progress state with respect to the service user with the provision period data representing the period during which the service is provided to the service user or the schedule period data representing the schedule period of the service user. The service evaluation part generates period improvement data representing an improvement point regarding the period of the service used by the service user. Consequently, the service operator can obtain an improvement point regarding the period of the service from the period improvement data generated by the service evaluation part. Therefore, the service operator can propose to, for example, the service provider providing the service using the IT resource, an improvement point regarding the period of the service.

In the above-mentioned service evaluation system according to the present invention, it is preferred that the interpretation result data further represents a performance state of the IT resource required in a progress state with respect to the service user, the service evaluation system further includes a performance data storage part that stores performance data representing a performance state of the IT resource in a period during which the service is provided to the service user, and the service evaluation part compares the interpretation result data extracted by the log extraction part with the performance data stored in the performance data storage part to further generate performance improvement data representing an improvement point regarding performance of the service used by the service user.

According to the above configuration, the service evaluation part compares the interpretation result data representing the performance state of the IT resource required in the progress state with respect to the service user with the performance data representing the performance state of the IT resource in the period during which the service is provided to the service user. The service evaluation part generates performance improvement data representing an improvement point regarding the performance of the service used by the service user. Consequently, the service operator can obtain an improvement point regarding the performance of the service from the performance improvement data generated by the service evaluation part. Therefore, the service operator can propose to, for example, the service provider providing the service using the IT resource, an improvement point regarding the performance of the service.

It is preferred that the above-mentioned service evaluation system according to the present invention further includes an interpretation condition data generation part that generates the interpretation condition data, based on the schedule period data stored in the period data storage part and the log data acquired by the log acquisition part.

According to the above configuration, the interpretation condition data generation part generates interpretation condition data, based on the schedule period data and the log data. Since the interpretation condition data generation part generates interpretation condition data, the time and labor of the service operator can be reduced compared with, for example, the embodiment in which the service operator generates interpretation condition data.

In the service evaluation system according to the present invention, it is preferred that the log data represents an access state to the service by the service user and an operation state of the IT resource, and the interpretation condition data represents a standard for interpreting the log data on a basis of the access state and the operation state.

According to the above configuration, the interpretation condition data represents the standard for interpreting the log data on the basis of the access state and the operation state. Consequently, the log evaluation part can extract interpretation result data stored in the interpretation data storage part, based on the standard on the basis of the access state and the operation state represented by the log data.

In order to achieve the above object, a service evaluation method according to the present invention is used for evaluating a service in an IT system providing the service to a service user using an IT resource operated by a service operator, wherein in a computer which is accessible to an interpretation data storage part that stores interpretation condition data representing a standard for interpreting log data of the IT resource and interpretation result data representing a use state of the service by the service user, associated with the interpretation condition data, the method includes acquiring, by the computer, the log data from a log data storage part storing the log data, and extracting, by the computer, the interpretation result data stored in the interpretation data storage part, in a case where the log data acquired by the computer satisfies the standard represented by the interpretation condition data.

In order to achieve the above object, a recording medium storing a service evaluation program according to the present invention causes a computer to execute processing for evaluating a service in an IT system providing the service to a service user using an IT resource operated by a service operator, wherein in the computer which is accessible to an interpretation data storage part that stores interpretation condition data representing a standard for interpreting log data of the IT resource and interpretation result data representing a use state of the service by the service user, associated with the interpretation condition data, the program causes the computer to execute acquiring the log data of the IT resource from a log data storage part storing the log data, and extracting the interpretation result data stored in the interpretation data storage part, in a case where the acquired log data satisfies the standard represented by the interpretation condition data.

The service evaluation method and the recording medium storing a program according to the present invention can obtain the same effects as those in the above-mentioned service evaluation system.

### BRIEF DESCRIPTION OF THE DRAWINGS

FIG. 1 is a conceptual diagram showing a schematic configuration of an IDC in Embodiment 1 of the present invention.

FIG. 2 is a diagram showing an example of a physical configuration of a service evaluation system and IT resources in an IT system of the above IDC.

FIG. 3 is a block diagram showing a schematic configuration in the above IT system.

FIG. 4 is a diagram showing an example of a data structure in an interpretation data storage part in the above service evaluation system.

FIG. 5 is a diagram showing an example of a data structure in the above interpretation data storage part.

FIG. 6 is a diagram showing an example of a data structure in a log evaluation storage part in the above service evaluation system.

FIG. 7 is a flowchart showing an operation of the above service evaluation system.

FIG. 8 is a block diagram showing a schematic configuration of an IT system in an IDC in Embodiment 2 of the present invention.

FIG. 9 is a diagram showing an example of a data structure in a contract data storage part in a service evaluation system of the above IT system.

FIG. 10 is a flowchart showing an operation of the above service evaluation system.

FIG. 11 is a block diagram showing a schematic configuration of an IT system in an IDC in Embodiment 3 of the present invention.

FIG. 12 is a diagram showing an example of a data structure in a schedule data storage part in a service evaluation system of the above IT system.

FIG. 13 is a block diagram showing a schematic configuration of an IT system in an IDC in Embodiment 4 of the present invention.

FIG. 14 is a conceptual diagram showing an example of average fluctuation data and time-series data in an item of a processor time of a CPU log.

FIG. 15 is a diagram showing an example of a data structure of interpretation condition data generated by an interpretation condition data generation part in a service evaluation system of the above IT system.

FIG. 16 is a flowchart showing an operation of the above interpretation condition data generation part.

FIG. 17 is a conceptual diagram showing a schematic configuration of an IDC in a conventional example.

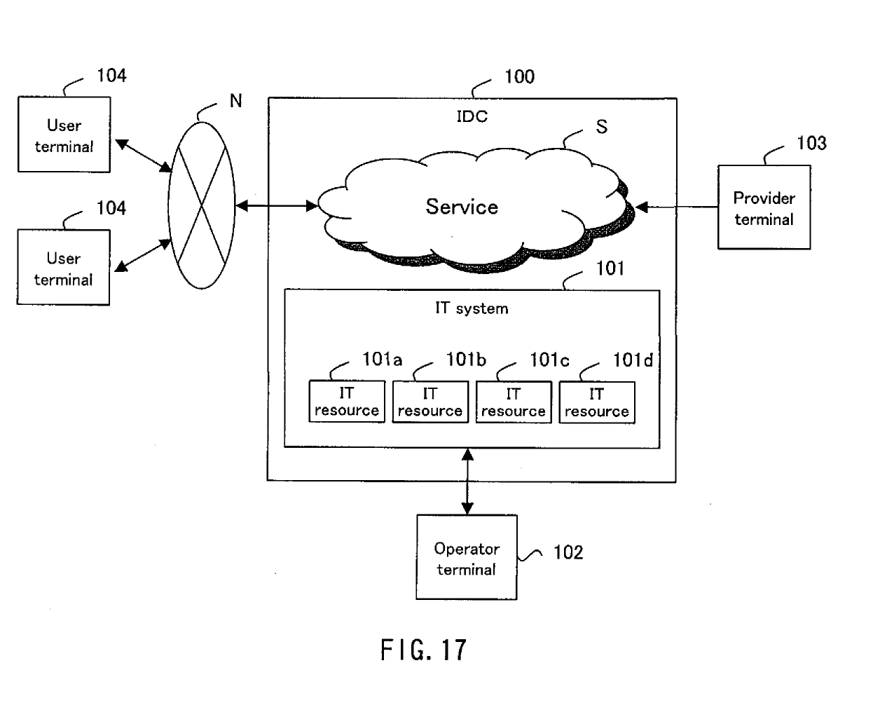

### DETAILED DESCRIPTION OF THE INVENTION

Hereinafter, the present invention will be described in detail by way of more specific embodiments with reference to the drawings.

### Embodiment 1

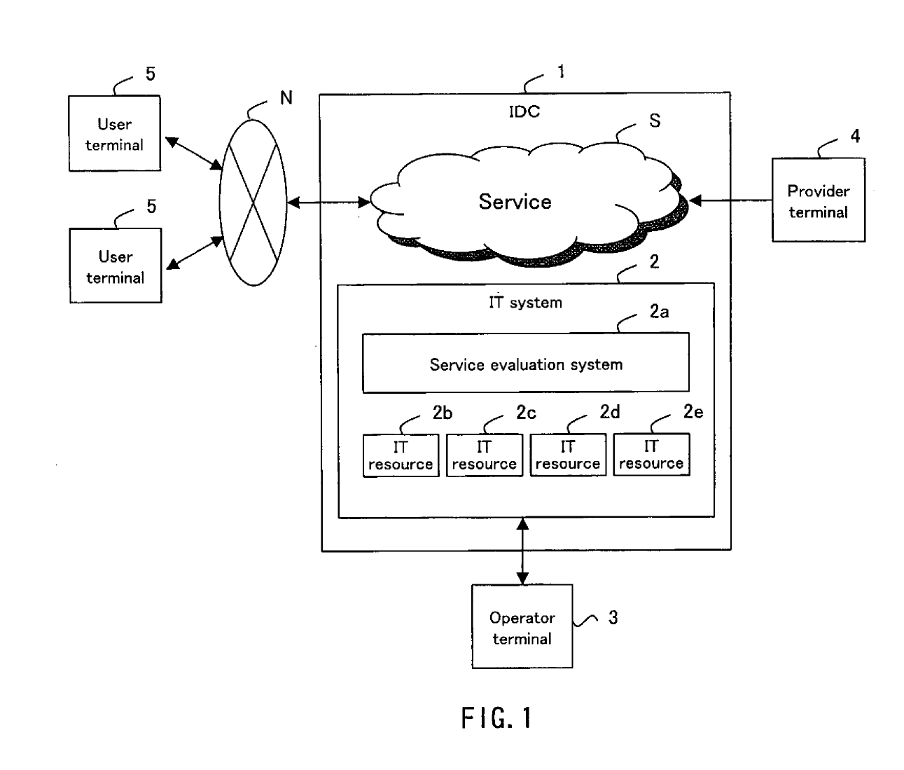

FIG. 1 is a conceptual diagram showing a system configuration of an IDC according to the present embodiment. More specifically, an IDC 1 according to the present embodiment includes an IT system 2. The IT system 2 further includes a service evaluation system 2a and IT resources 2b to 2e.

In the IDC 1 according to the present embodiment, a service operator extracts the IT resources 2b to 2e provided in the IT system 2, and lends the extracted IT resources 2b to 2e to a service provider, using an operator terminal 3. The service provider downloads software to the lent IT resources 2b to 2e using a provider terminal 4, thereby providing various services S to service users. The service users use the services S provided by the service provider via an Internet N, using user terminals 5. In FIG. 1, for simplicity of description, although the four IT resources 2b to 2e are shown, the number of the IT resources 2b to 2e constituting the IT system 2 is not limited. Furthermore, a plurality of service providers may be present and provide a plurality of services S using a plurality of provider terminals 4. Furthermore, the number of the user terminals 5 using the services S is not limited.

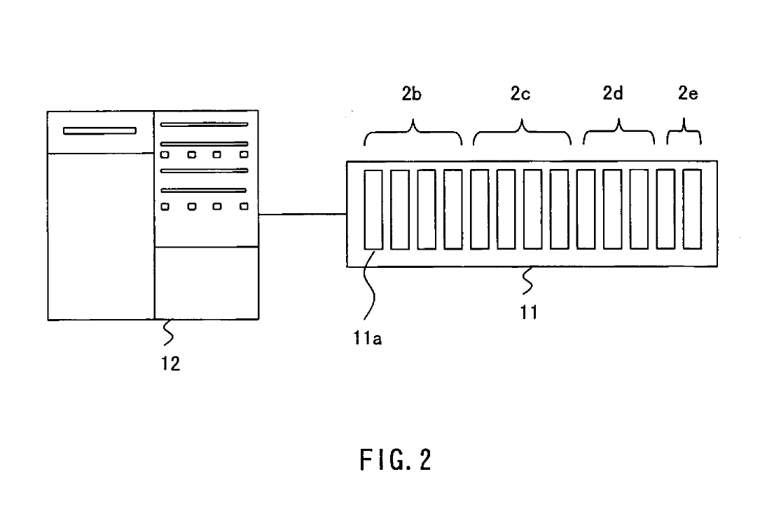

FIG. 2 is a diagram showing a physical configuration of the service evaluation system 2a and the IT resources 2b to 2e. As shown in FIG. 2, the service evaluation system 2a and the IT resources 2b to 2e are composed of, for example, a blade server 11 including a plurality of server blades 11a and a deployment server 12 managing the blade server 11. The blade server 11 and the deployment server 12 are connected to each other via, for example, a local area network (LAN). The service evaluation system 2a can be constructed on the deployment server 12. A plurality of server blades 11a in one blade server 11 are allocated to, for example, the IT resources 2b to 2e. For example, in the case of adding one server in the IT system 2, one server blade 11a in the blade server 11 is added. The IT resources 2b to 2e can also be composed of blade servers that are physically independent from each other.

In the present embodiment, as an example, the case will be described in which the user terminal 5 used by the service user accesses an IT resource (CAD server) in the services S provided by the service provider via the Internet N, and a CAD project is performed by the service user.

### (Configuration of an IT System)

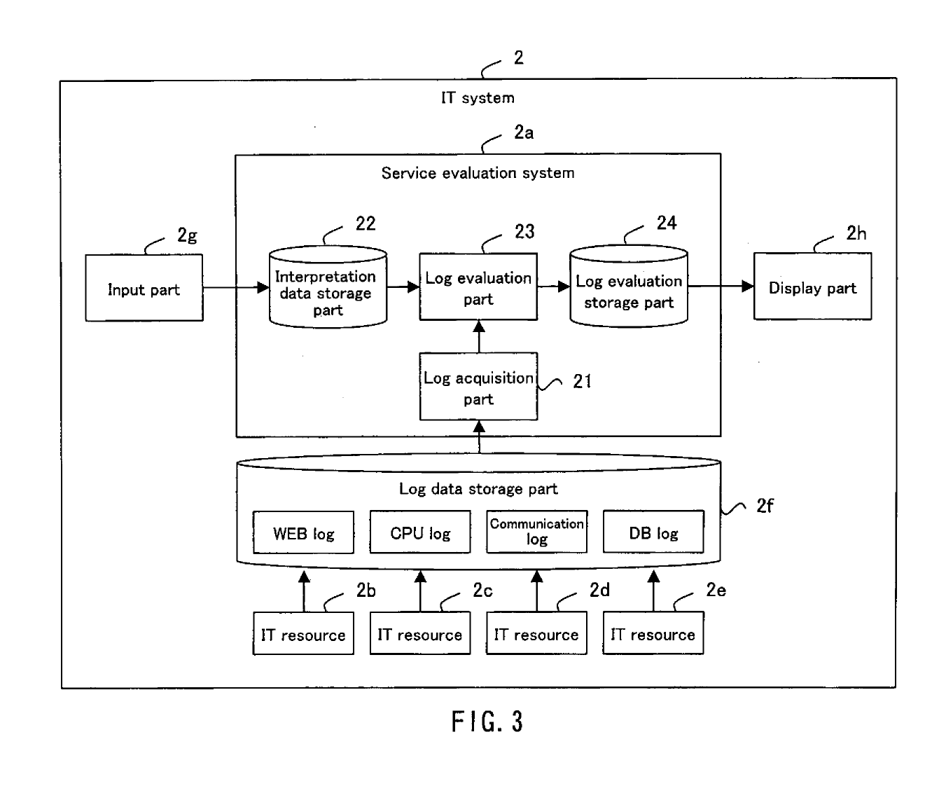

FIG. 3 is a block diagram showing a schematic configuration of the IT system 2 according to the present embodiment. More specifically, the IT system 2 according to the present embodiment includes the service evaluation system 2a, the IT resources 2b to 2e, a log data storage part 2f, an input part 2g, and a display part 2h.

The service evaluation system 2a evaluates the services S used by the service users. The detail of the service evaluation system 2a will be described later.

The IT resources 2b to 2e are a server, a storage, a network, and software that operates them. The IT resources 2b to 2e include, for example, middleware, various terminals (a personal computer, a PDA, a mobile telephone, etc.) in addition to the server, the storage, and the network. The IT resources 2b to 2e are operated by a service operator.

The log data storage part 2f stores log data representing an access state by the service users with respect to the services S and an operation state of the IT resources 2b to 2e. The log data storage part 2f is constructed, for example, on the above deployment server 12, and is formed as one region of hardware in the deployment server 12. The log data represents, for example, a Web log, a CPU log, a communication log, and a database (DB) log. The Web log and the communication log show the access state by the service users with respect to the services S. The CPU log and the DB log represent the operation state of the IT resources 2b to 2e.

The Web log includes items such as a client name of the user terminal 5 that accesses, an access date and time, a requested film name, a hyper text transfer protocol (HTTP) state code, a referrer representing a uniform resource locator (URL) of a Web page accessed immediately before, and user environment data representing the environment of the user terminal 5. The CPU log includes items such as a processor time, a CPU use ratio, a CPU wait request number, a disk use time, a physical disk busy percentage, a physical disk wait request number, a disk use ratio, an available memory capacity, and a page file size. The communication log includes items such as a communication amount of the Internet N. The DB log includes items such as a DB input/output, a DB-based input/output number, connection pool information, connection acquisition wait information, and physical connection establishment information. As the log data, in addition to the above, for example, an authentication log and a firewall log may be included.

The input part 2g enables the service operator to input an interpretation condition representing the standard for interpreting the log data, and an interpretation result representing the use state of the services S by the service users, associated with the interpretation condition. The interpretation condition and the interpretation result may be input through the operator terminal 3 in place of the input part 2g. The interpretation condition and the interpretation result input by the service operator are stored in an interpretation data storage part 22 described later. The input part 2g is composed of any input devices such as a keyboard, a mouse, a ten-key, a tablet, a touch panel, and a voice recognition apparatus.

The display part 2h is composed of a liquid crystal display, an organic EL display, a plasma display, a CRT display, or the like. The input part 2g and the display part 2h are constructed on an input apparatus and a display apparatus (not shown) connected to the blade server 11 or the deployment server 12.

### (Configuration of a Service Evaluation System)

As shown in FIG. 3, the service evaluation system 2a includes a log acquisition part 21, an interpretation data storage part 22, a log evaluation part 23, and a log evaluation storage part 24. The service evaluation system 2a can also be constructed on, for example, a computer such as a personal computer or a server, instead of the deployment server 12. Furthermore, the log acquisition part 21, the interpretation data storage part 22, the log evaluation part 23, and the log evaluation storage part 24 constituting the service evaluation system 2a may be configured in one apparatus in the mass, or may be configured so as to be distributed in a plurality of apparatuses.

The log acquisition part 21 acquires the log data stored in the log data storage part 2f. The log acquisition part 21 outputs the acquired log data to the log evaluation part 23. The log acquisition part 21 may acquire the log data sequentially for each of the Web log, the CPU log, the communication log, and the DB log, or may acquire these logs in the mass. Furthermore, the log acquisition part 21 may allow, for example, a storage apparatus such as a hard disk to store the acquired log data.

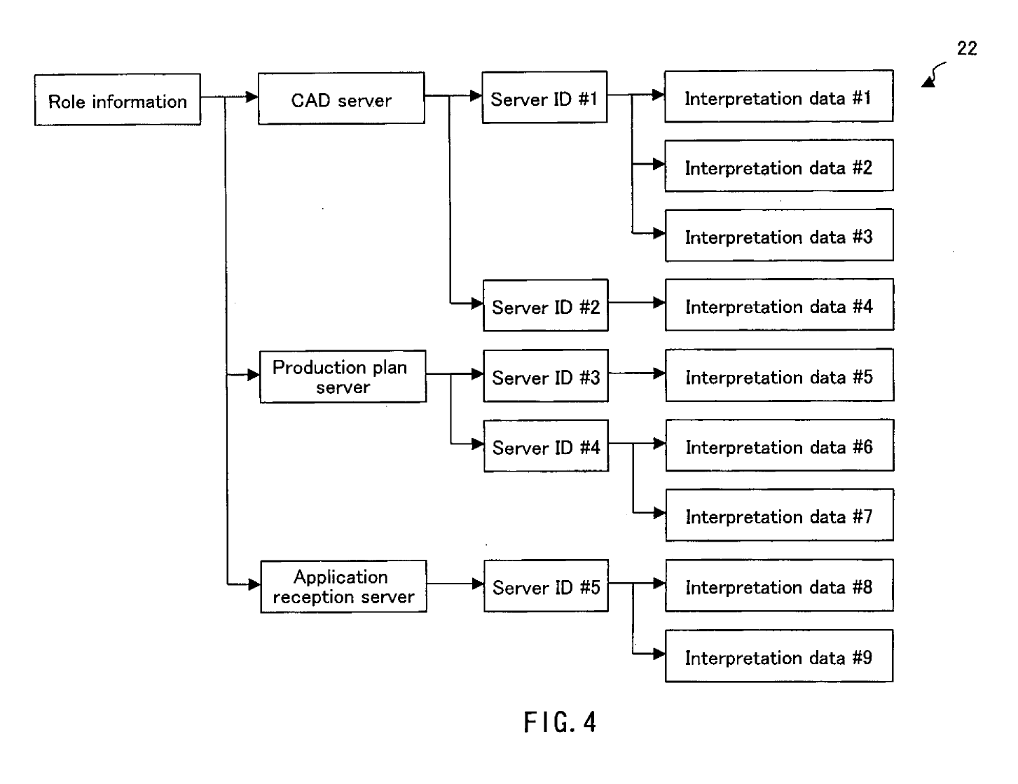

The interpretation data storage part 22 stores, as interpretation data, interpretation condition data that represents the standard for interpreting the log data and interpretation result data that represents the use state of the services S by the service users, associated with the interpretation condition data. FIG. 4 is a diagram showing an example of a data structure of interpretation data stored in the interpretation data storage part 22. The interpretation data shown in FIG. 4 may be described in, for example, a schema language for an extensible markup language (XML), and the description format of the interpretation data is not limited.

In the schema shown in FIG. 4, “role information” is associated with data representing a “CAD server”, data representing a “production plan server”, and data representing an “application reception server”. The “role information” relates to what purpose the IT resources 2b to 2e are operated for. For example, the data representing the “CAD server” shows that the CAD server is used for design or development in a CAD project. The data representing the “production plan server” shows that the production plan server is used for planning a production in a CAD project. The Data representing the “application reception server” shows that the application reception server is capable of receiving various applications.

The data representing the “CAD server” is associated with “server ID #1” and “server ID #2”. Furthermore, the data representing the “production plan server” is associated with “server ID #3” and “server ID #4”. Furthermore, the data representing the “application reception server” is associated with “server ID #5”. A server ID is information for identifying the IT resources 2b to 2e physically or information for identifying the IT resources 2b to 2e virtually.

The “server ID #1” is associated with “interpretation data #1 to #3”. The “server ID #2” is associated with the “interpretation data #4”. The “server ID #3” is associated with “interpretation data #5”. The “server ID #4” is associated with “interpretation data #6” and “interpretation data #7”. The “server ID #5” is associated with “interpretation data #8” and “interpretation data #9”. The interpretation data is allowed to correspond to the interpretation condition data representing the standard for interpreting the log data and the interpretation condition data thereof, and contains interpretation result data representing the use state of the services S by the service users.

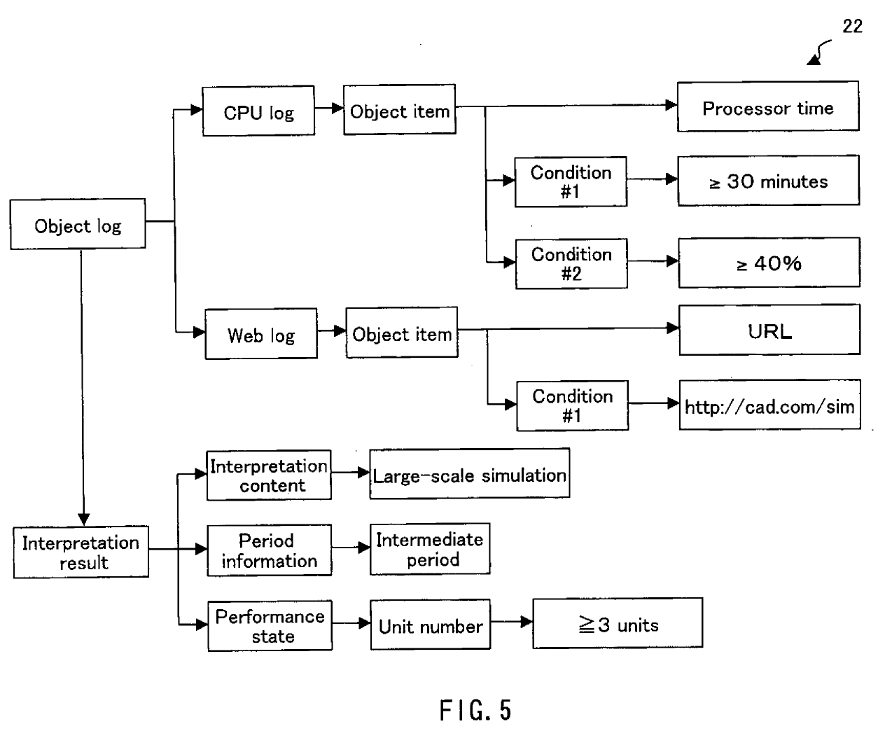

FIG. 5 is a diagram showing an example of the data structure of the “interpretation data #1” associated with the “server ID #1”. The data structures of the “interpretation data #2 to #9” are also substantially similar to that of the “interpretation data #1” shown in FIG. 5. The schema shown in FIG. 5 includes data representing an “object log” as the interpretation condition data and data representing an “interpretation result” as the interpretation result data.

The data representing the “object log” is associated with data representing a “CPU log” and data representing a “Web log”. The data representing the “object log” represents a log to be an object for interpreting the log data. In an example shown in FIG. 5, the “CPU log” and the “Web log” represent logs to be objects for interpreting the log data.

The data representing the “CPU log” is associated with data representing a “processor time” as an “object item”. Furthermore, the data representing the “CPU log” is associated with data representing “≧30 minutes” as “condition #1” of the “object item”. Furthermore, the data representing the “CPU log” is associated with data representing “≧40%” as “condition #2” of the “object item”. More specifically, the example shown in FIG. 5 shows the standard for determining whether or not the “processor time” of the “CPU log” shows the abnormality exceeding “40%” over “30 minutes” or longer.

The data representing the “Web log” is associated with data representing a “URL” as the “object item”. Furthermore, the data representing the “Web log” is associated with data representing “http://cad.com/sim” as the “condition #1” of the “object item”. More specifically, the example in FIG. 5 shows the standard for whether or not the “URL” of the “Web log” shows an access to the “http://cad.com/sim”.

The data representing the “interpretation result” is associated with data representing the “object log” as the interpretation condition data. The data representing the “interpretation result” is associated with an “interpretation content”, “period information”, and a “performance state”. The data representing the “interpretation result” represents the use state of the services S by the service users in the case where the log data acquired by the log acquisition part 21 satisfies the standard represented by the interpretation condition data. More specifically, the example in FIG. 5 shows the use state of the services S by the service users in the case where the “condition #1” and the “condition #2” associated with the data represented by the “CPU log”, and the “condition #1” associated with the data represented by the “Web log” are satisfied.

The “interpretation content” is associated with data representing a “large-scale simulation”. The “period information” is associated with data representing an “intermediate period”. The “performance state” is associated with data representing “≧3 units” as a “unit number”. More specifically, the example in FIG. 5 shows the interpretation result in which, in the case where the “processor timer” of the “CPU log” shows the abnormality exceeding “40%” over “30 minutes” or longer, and the “URL” of the “Web log” shows an access to the “http://cad.com/sim”, the services S used by the service users are performing the “large-scale simulation”. Furthermore, since the “large-scale simulation” is being performed, the example shows the interpretation result in which the progress state of the CAD project is in an “intermediate period”. Furthermore, the example shows the interpretation result in which “3 units” or more CAD servers are required as the performance state required in the “intermediate period” in the “large-scale simulation” of the CAD project.

The log evaluation part 23 determines whether or not the log data acquired by the log acquisition part 21 satisfies the standard represented by the interpretation condition data stored in the interpretation data storage part 22. In the case where the log data acquired by the log acquisition part 21 satisfies the standard represented by the interpretation condition data, the log evaluation part 23 extracts the interpretation result data allowed to correspond to the interpretation condition data from the interpretation data storage part 22. The log evaluation part 23 outputs the extracted interpretation result data to the log evaluation storage part 24.

More specifically, in the example shown in FIG. 5, in the case where the “processor time” of the “CPU log” shows the abnormality exceeding 40%” over “30 minutes” or longer and the “URL” of the “Web log” shows an access to the “http://cad.com/sim”, the log evaluation part 23 extracts interpretation result data representing the interpretation content “large-scale simulation”, the period information “intermediate period”, and the unit number of a performance state “≧3 units”. The log evaluation part 23 performs the same processing as the above, even with respect to the “interpretation data #2 to #9”. The log evaluation part 23 writes the extracted interpretation result data in the log evaluation storage part 24. In the present embodiment, it is assumed that the log evaluation part 23 extracts only the interpretation result data of the “interpretation data #1”, and does not extract the interpretation result data of the “Interpretation data #2 to #9”.

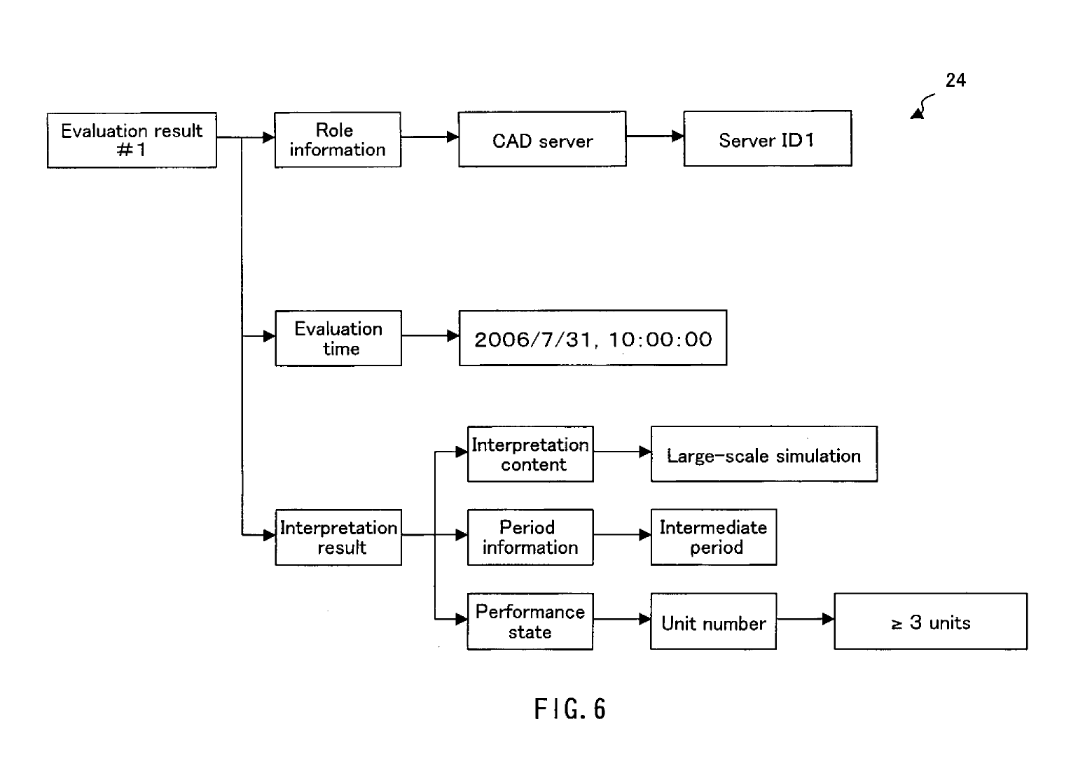

The log evaluation storage part 24 stores evaluation result data containing the interpretation result data extracted by the log evaluation part 23. FIG. 6 is a diagram showing an example of a data structure of the evaluation result data stored in the log evaluation storage part 24. In the schema shown in FIG. 6, the “evaluation result #1” is associated with “role information”, an “evaluation time”, and an “interpretation result”.

The “role information” is associated with data representing a “CAD server”. Furthermore, the data representing the “CAD server” is associated with “server ID #1”.

The “evaluation time” is associated with data representing “2006/7/31, 10:00:00”. In the present embodiment, the “evaluation time” represents a time at which the log evaluation part 23 writes the interpretation result data in the log evaluation storage part 24. The example in FIG. 6 shows that the log evaluation part 23 has written the interpretation result data in the log evaluation storage part 24 at 10:00:00 on Jul. 31, 2006. In the above, the example has been described, which shows a time at which the log evaluation part 23 writes the interpretation result data in the log evaluation storage part 24 as an evaluation time; however, the present invention is not limited thereto. For example, as an evaluation time, a time at which the log evaluation part 23 extracts the interpretation result data from the interpretation data storage part 22 may be used.

The “interpretation result” is associated with an “interpretation content”, “period information”, and a “performance state” as the interpretation result data. The “interpretation result” is associated with data representing a “large-scale simulation”. The “period information” is associated with data representing an “intermediate period”. The “performance state” is associated with data representing “≧ 3 units” as a “unit number”. More specifically, in the example shown in FIG. 6, the “server ID #1” operated as the “CAD server” is interpreted as performing the “large-scale simulation” according to the evaluation result of 10:00:00 on Jul. 31, 2006. Furthermore, since the “server ID #1” is performing the “large-scale simulation”, the progress state of the CAD project is interpreted to be in the “intermediate period”. Furthermore, as the performance state required in the “intermediate period” in the “large-scale simulation” of the CAD project, it is interpreted that “3 units” or more CAD servers are required.

The evaluation result data stored in the log evaluation storage part 24 is output to the display part 2h based on an instruction from the display part 2h. The display part 2h displays the output evaluation result data. More specifically, the display part 2h displays the role information “CAD server”, “server ID #1”, the evaluation time “10:00:00 on Jul. 31, 2006”, the interpretation content “large-scale simulation”, the period “intermediate period”, and the unit number “≧3 units”. Consequently, the service operator can obtain improvement points of the services S based on the evaluation result data displayed in the display part 2h.

Specifically, for example, it is assumed that, as the contract content between a service operator and a service provider, the lending period of the IT resources 2b to 2e operated by the service operator is up to Jul. 31, 2006. In such a case, due to the evaluation time “10:00:00 on Jul. 31, 2006” and the period “intermediate period” displayed on the display part 2h, it is understood that the progress of the CAD project performed by the service user is still in an “intermediate period”, irrespective of that fact that the lending period of the IT resources 2b to 2e is at the point of completion of the IT resources 2b to 2e. Thus, the service operator can obtain improvement points of the services S: “it is necessary to extend the lending period of the IT resources”. Therefore, the service operator can suggest, to the service provider, for example, “it is better to extend the lending period of the IT resources”.

It is also possible for the service operator to predict the period up to the completion of the CAD project, based on the fact that the progress of the CAD project is in the “intermediate period”. In such a case, the service operator can also suggest, to the service provider, specifically, for example, “it is better to extend the lending period of the IT resources for 20 days”.

Furthermore, for example, it is assumed that the number of lending units with respect to the service provider of the IT resources 2b to 2e operated by the service operator is two, as a contract content between the service operator and the service provider. In such a case, due to the unit number “≧3 units” displayed on the display part 2h, it is understood that the CAD project is operated by two CAD servers irrespective of the fact that 3 or more CAD servers (IT resources) are required in the large-scale simulation in the CAD project. Thus, the service operator can obtain improvement points of the services S: “it is necessary to increase the lending number of the IT resources”. Therefore, the service operator can suggest, to the service provider, for example, “it is better to increase the lending number of the IT resources”. The service operator can also suggest, to the service provider, for example, “it is better to increase the lending number of the IT resources by one”.

More specifically, the service operator can suggest, to the service provider, the improvement points of the services S quantified so as to be determined as a management index. The service provider makes a management determination of whether to extend the lending period of the IT resources 2b to 2e or to increase the number of lending units of the IT resources 2b to 2e, based on the suggested improvement points of the services S. The service operator, for example, extends the lending period of the IT resources 2b to 2e or increases the number of lending units of the IT resources 2b to 2e, based on a request from the service provider.

The service evaluation system 2a can also be realized by installing a program in any computer such as a personal computer. More specifically, the log acquisition part 21 and the log evaluation part 23 are embodied when a CPU of the computer is operated in accordance with a program for realizing the functions thereof. Thus, a program for realizing the functions of the log acquisition part 21 and the log evaluation part 23 or a recording medium storing the program are also included in one embodiment of the present invention. Furthermore, the interpretation data storage part 22 and the log evaluation storage part 24 are embodied by a storage apparatus contained in the computer or a storage apparatus accessible from the computer.

### (Operation of a Service Evaluation System)

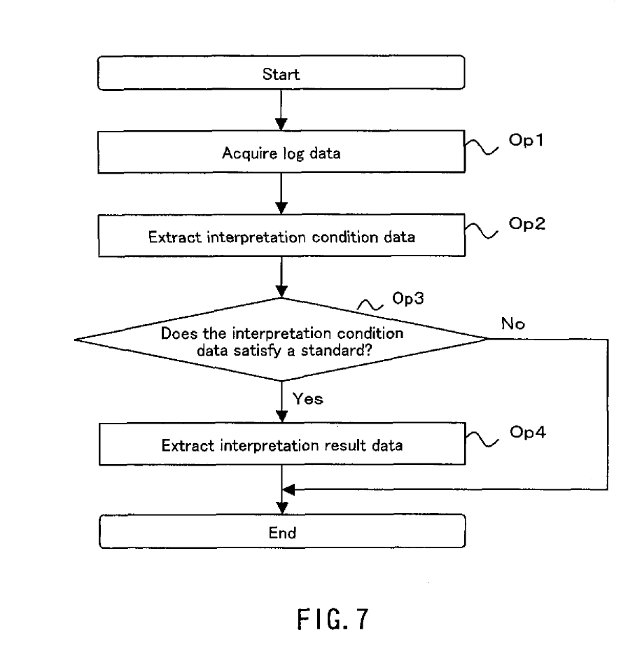

Next, the processing of the service evaluation system 2a according to the above configuration will be described with reference to FIG. 7.

FIG. 7 is a flowchart showing an outline of the processing of the service evaluation system 2a. More specifically, as shown in FIG. 7, a log acquisition part 21 acquires log data stored in the log data storage part 2f (Op 1). Then, the log evaluation part 23 extracts interpretation condition data stored in the interpretation data storage part 22 (Op 2).

When the log data acquired in Op 1 satisfies the standard represented by the interpretation condition data extracted in Op 2 (YES in Op 3), the log evaluation part 23 extracts the interpretation result data stored in the interpretation data storage part 22 (Op 4). The log evaluation part 23 writes the extracted interpretation result data in the log evaluation storage part 24. On the other hand, when the log data acquired in Op 1 does not satisfy the standard represented by the interpretation condition data extracted in Op 2 (NO in Op 3), the process is completed.

The display part 2h displays evaluation result data containing the interpretation result data stored in the log evaluation storage part 24. The service operator can obtain improvement points of the services S based on the evaluation result data displayed on the display part 2h.

In the present embodiment, although the case has been described in which the user terminal 5 used by the service user accesses a CAD server in the services S provided by the service provider via the Internet N, and a CAD project is performed by the service user, the present invention is not limited thereto. Needless to say, for example, the present invention can be applied to even the case of an enterprise information portal (EIP), reception of an application/procedure, management of acceptance/placement of an order, e-commerce, e-learning, management of texts, and the like, as one example of the services S provided by the service provider.

Furthermore, in the present embodiment, although an example of the unit number of CAD servers has been described as the performance state of the interpretation result data stored in the interpretation data storage part 22, the present invention is not limited thereto. For example, as the performance state of the interpretation result data, the capacity of a storage and the capacity of a memory in the CAD server may be used.

Furthermore, in the present embodiment, although an example has been described in which the server operator can obtain improvement points of the services S: “it is necessary to extent the lending period of the IT resources” or “it is necessary to increase the number of lending units of the IT resources”, the present invention is not limited thereto. For example, the service operator can also obtain improvement points of the services S: “it is necessary to shorten the lending period of the IT resources” or “it is necessary to decrease the number of lending units of the IT resources” from the interpretation result data extracted by the log evaluation part 23.

As described above, according to the service evaluation system 2a in the present embodiment, the log evaluation part 23 can extract the interpretation result data stored in the interpretation data storage part 22, when the log data acquired by the log acquisition part 21 satisfies the standard represented by the interpretation condition data. The interpretation result data represents the use state of the services S by the service users. Furthermore, the log evaluation part 23 outputs the extracted interpretation result data, so that the service operator can obtain improvement points of the services S from the use state of the services S by the service users. Therefore, the service operator can suggest, for example, to the service provider that provides the services S using the IT resources 2b to 2e, the improvement points of the services S.

### Embodiment 2

In Embodiment 1, an example has been described in which the service operator obtains improvement points of services based on the evaluation result data stored in the log evaluation storage part. In contrast, in Embodiment 2, an example will be described in which the service operator obtains improvement points of services based on the improvement data generated by the service evaluation part.

### (Configuration of an IT System)

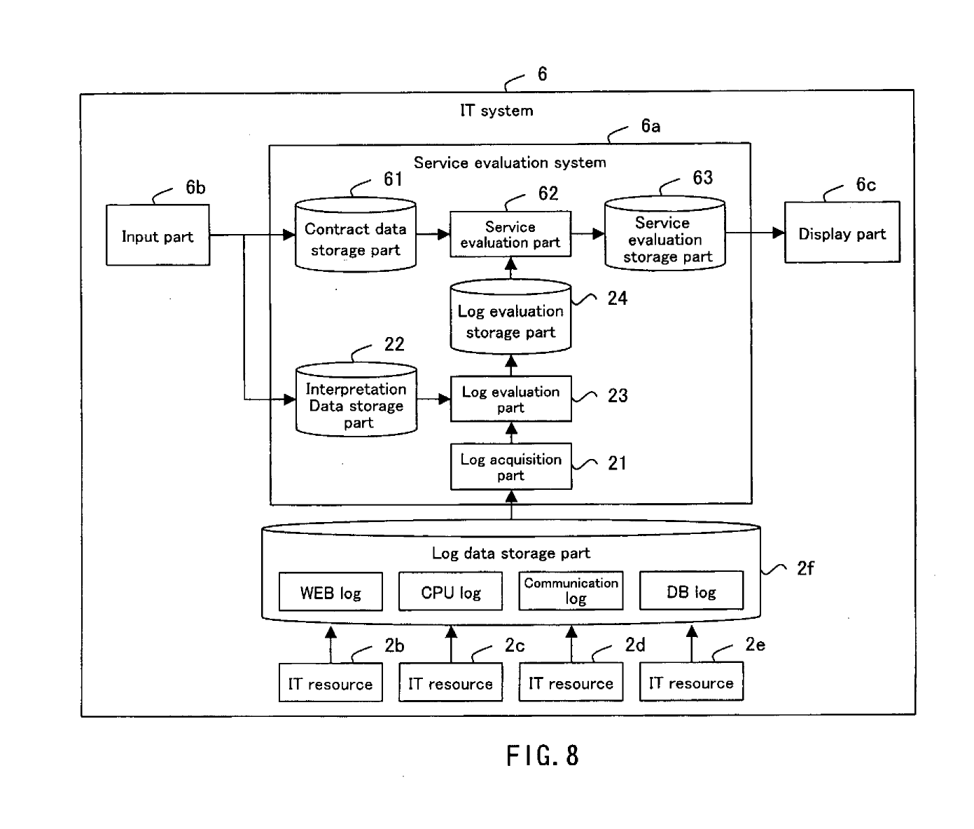

FIG. 8 is a block diagram showing a schematic configuration of an IT system 6 according to the present embodiment. More specifically, the IT system 6 according to the present embodiment includes a service evaluation system 6a, an input part 6b, and a display part 6c in place of the service evaluation system 2a, the input part 2g, and the display part 2h shown in FIG. 1. In FIG. 8, components having the same functions as those of the components in FIG. 1 are denoted with the same reference numerals as those therein, and the detailed description thereof will be omitted.

The service evaluation system 6a evaluates the services S used by service users. The detail of the service evaluation system 6a will be described later.

The input part 6b has a function of enabling a service operator to input a contract content between the service operator and a service provider, in addition to the function of the input part 2g in FIG. 1. The contract content may be input through the operator terminal 3 in place of the input part 6b. The contract contents input by the service operator are stored in a contract data storage part 61 described later.

The display part 6c is composed of a liquid crystal display, an organic EL display, a plasma display, and a CRT display in the same way as in the display part 2h in FIG. 1.

### (Configuration of a Service Evaluation System)

The service evaluation system 6a includes a contract data storage part 61, a service evaluation part 62, and a service evaluation storage part 63 in addition to the service evaluation system 2a shown in FIG. 1. The service evaluation system 6a can also be constructed on, for example, a computer such as a personal computer and a server, instead of the deployment server 12, in the same way as in the service evaluation system 2a. Furthermore, the contract data storage part 61, the service evaluation part 62, and the service evaluation storage part 63 constituting the service evaluation system 6a may be configured in one apparatus in the mass or may be configured so as to be distributed in a plurality of apparatuses.

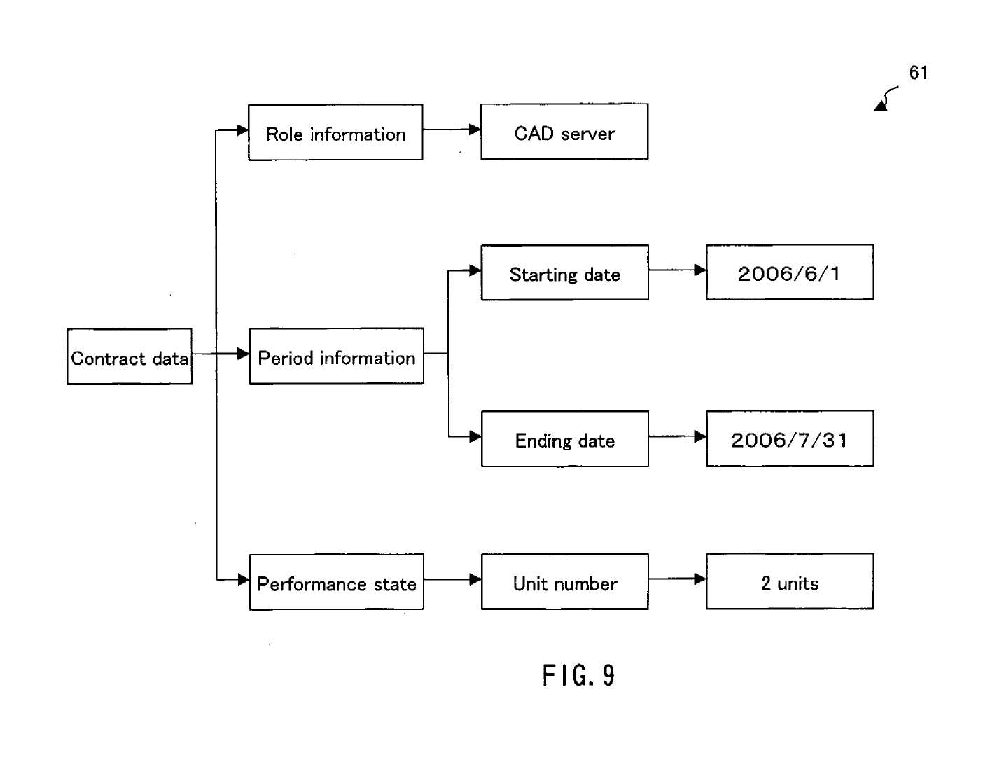

The contract data storage part (a period data storage part, a performance data storage part) 61 stores contract data representing the a contract content between the service operator and the service provider. The contract content between the service operator and the service provider include, for example, the lending period of the IT resources 2b to 2e operated by the service operator, and the number of lending units of the IT resources 2b to 2e. In the present embodiment, the contract between the service operator and the service provider is made based on a service level agreement (SLA). FIG. 9 shows an example of a data structure of contract data stored in the contract data storage part 61. In the schema shown in FIG. 9, “contract data” is associated with “role information”, “period information”, and a “performance state”.

The “role information” is associated with data representing a “CAD server”. The example shown in FIG. 9 shows that the service provider uses the IT resources 2b to 2e operated by the service operator as the CAD server.

The “period information” (provision period data) is associated with data representing “2006/6/1” as a starting date, and data representing “2006/7/31” as an ending date. In the example shown in FIG. 9, “the period information” shows that the contract period between the service operator and the service provider is from Jun. 1, 2006 to Jul. 31, 2006. More specifically, the “period information” shown in FIG. 9 represents a period during which the services S are provided to service users.

The “performance state” (performance data) is associated with data representing “2 units” as a “unit number”. In the example shown in FIG. 9, “the performance state” shows that the number of lending units of the IT resources 2b to 2e during the contract period from Jun. 1, 2006 to Jul. 31, 2006 is “2 units”.

The service evaluation part 62 compares the evaluation result data stored in the log evaluation storage part 24 with the contract data stored in the contract data storage part 61 to generate improvement data (period improvement data, performance improvement data) representing improvement points of the services S. The service evaluation part 62 outputs the generated improvement data to the service evaluation storage part 63.

Specifically, the service evaluation part 62 extracts an ‘evaluation time’ and “period information” in the evaluation result data stored in the log evaluation storage part 24. In the present embodiment, the service evaluation part 62 extracts an evaluation time “2006/7/31, 10:00:00” and period information “intermediate period”. The service evaluation part 62 extracts the “period information” in the contract data stored in the contract data storage part 61. In the present embodiment, the service evaluation part 62 extracts a starting date “2006/6/1” and an ending date “2006/7/31”.

The service evaluation part 62 compares the evaluation time “2006/7/31, 10:00:00” and the period information “intermediate period” in the evaluation result data with the starting date “2006/6/1” and the ending date “2006/7/31” in the contract data. As a result of the comparison, the service evaluation part 62 determines that the services S used by service users fall on the ending date (final date: Jul. 31, 2006) of the contract period in the contract between the service operator and the service provider. Furthermore, the service evaluation part 62 determines that the progress of the CAD project performed by the service users is still in an intermediate period, irrespective of the fact that the services S fall on the final date of the contract period. As a result of the determination, the service evaluation part 62 generates, for example, period improvement data representing “it is necessary to extend the lending period of the IT resources”.

It is also possible for the service evaluation part 62 to calculate a period up to the completion of the CAD project since the progress of the CAD project is in an “intermediate period”. In such a case, the service evaluation part 62 can also generate period improvement data representing, for example, “it is necessary to extend the lending period of the IT resources for 20 days”.

Furthermore, the service evaluation part 62 extracts the “performance state” in the evaluation result data stored in the log evaluation storage part 24. In the present embodiment, the service evaluation part 62 extracts the performance state “≧3 units”. Furthermore, the service evaluation part 62 extracts the “performance state” in the contract data stored in the contract data storage part 61. In the present embodiment, the service evaluation part 62 extracts the performance state “2 units”.

The service evaluation part 62 compares the performance state “≧3 units” in the evaluation result data with the performance state “2 units” in the contract data. As a result of the comparison, the service evaluation part 62 determines that the CAD project is operated by two CAD servers irrespective of the fact that 3 or more CAD servers (IT resources) are required in the large-scale simulation in the CAD project. As a result of the determination, the service evaluation part 62 generates, for example, performance improvement data representing “it is necessary to increase the number of lending units of the IT resources”. The service evaluation part 62 can also generate, for example, performance improvement data representing “it is necessary to increase the number of lending units of the IT resources by one”.

The service evaluation storage part 63 stores the period improvement data and the performance improvement data representing improvement points of the services S generated by the services evaluation part 62. The service evaluation storage part 63 stores, for example, the period improvement data representing “it is necessary to extent the lending period of the IT resources” generated by the service evaluation part 62 and the performance improvement data representing “it is necessary to increase the number of lending units of the IT resources”.

The period improvement data and the performance improvement data stored in the service evaluation storage part 63 are output to the display part 6c based on an instruction from the display part 6c. The display part 6c displays the output period improvement data and performance improvement data. More specifically, the display part 6c displays “it is necessary to extend the lending period of the IT resources” and “it is necessary to increase the number of lending units of the IT resources”. Consequently, the service operator can obtain improvement points of the services S based on at least one of the period improvement data and the performance improvement data displayed in the display part 6c.

Specifically, for example, in the case where the display part 6c displays “it is necessary to extend the lending period of the IT resources”, the service operator can obtain improvement points of the services S displayed on the display part 6c. Therefore, the service operator can suggest, to the service provider, for example, “it is better to extend the lending period of the IT resources”. Furthermore, for example, in the case where the display part 6c displays “it is necessary to extend the lending period of the IT resources for 20 days”, the service operator can obtain improvement points of the services S displayed on the display part 6c. Therefore, the service operator can specifically suggest, to the service provide, for example, “it is better to extend the lending period of the IT resources for 20 days”.

Furthermore, for example, in the case where the display part 6c displays “it is necessary to increase the number of lending units of the IT resources”, the service operator can obtain improvement points of the services S displayed on the display part 6c. Therefore, the service operator can suggest, to the service provider, for example, “it is better to increase the number of lending units of the IT resources”. Furthermore, for example, in the case where the display part 6c displays “it is necessary to increase the number of lending units of the IT resources by one”, the service operator can obtain improvement points of the services S displayed on the display part 6c. Therefore, the service operator can specifically suggest, to the service provider, for example, “it is better to increase the number of lending units of the IT resources by one”.

The service evaluation system 6a can also be realized by installing a program in any computer such as a personal computer. More specifically, the service evaluation part 62 is embodied when a CPU of the computer is operated in accordance with the program realizing the function thereof. Thus, a program for realizing the function of the service evaluation part 62 and a recording medium storing the program are also included in one embodiment of the present invention. Furthermore, the contract data storage part 61 and the service evaluation storage part 63 are embodied by a storage apparatus contained in the computer or a storage apparatus accessible from the computer.

### (Operation of a Service Evaluation System)

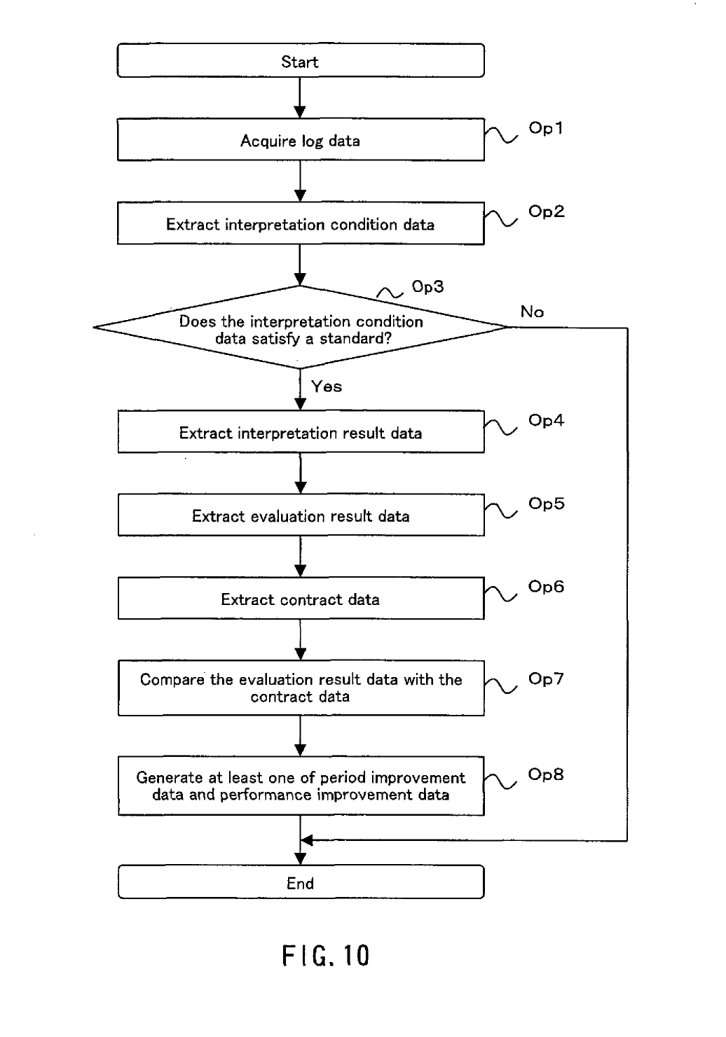

Next, the processing of the service evaluation system 6a according to the above configuration will be described with reference to FIG. 10. In FIG. 10, portions showing the same processing as that of the portions in FIG. 7 are denoted with the same reference numerals as those therein, and the detailed description thereof will be omitted.

FIG. 10 is a flowchart showing an outline of the processing of the service evaluation system 6a. In the processing shown in FIG. 10, Op 1 to Op 4 are the same as Op 1 to Op 4 shown in FIG. 7.

After Op 4, the service evaluation part 62 extracts the evaluation result data stored in the log evaluation storage part 24 (Op 5). Furthermore, the service evaluation part 62 extracts the contract data stored in the contract data storage part 61 (Op 6). Then, the service evaluation part 62 compares the evaluation result data extracted in Op 5 with the contract data extracted in Op 6 (Op 7). The service evaluation part 62 generates at least one of the period improvement data and the performance improvement data, based on the result of the comparison in Op 7 (Op 8). The service evaluation part 62 writes at least one of the generated period improvement data and performance improvement data in the service evaluation storage part 63.

The display part 6c displays at least one of the period improvement data and the performance improvement data stored in the service evaluation storage part 63. Consequently, the service operator can obtain improvement points of the services S, based on at least one of the period improvement data and the performance improvement data displayed on the display part 6c.

In the present embodiment, although the example has been described in which the service evaluation part 62 generates the period improvement data representing “it is necessary to extend the lending period of the IT resources” or the performance improvement data representing “it is necessary to increase the number of lending units of the IT resources”, the present invention is not limited thereto. For example, the service evaluation part 62 can also generate the period improvement data representing “it is necessary to shorten the lending period of the IT resources” or the performance improvement data representing “it is necessary to decrease the number of lending units of the IT resources”, from the result of the comparison between the evaluation result data stored in the log evaluation storage part 24 and the contract data stored in the contract data storage part 61.

As described above, according to the service evaluation system 6a in the present embodiment, the service evaluation part 62 compares the interpretation result data representing the progress state with respect to service users with the provision period data representing a period during which the services S are provided to the service users. The service evaluation part 62 generates period improvement data representing improvement points regarding the period of the services S used by the service users. Consequently, the service operator can obtain improvement points regarding the period of the services S from the period improvement data generated by the service evaluation part 62. Therefore, the service operator can suggest, for example, improvement points regarding the period of the services S, to the service provider that provides the services S using the IT resources 2b to 2e.

Furthermore, according to the service evaluation system 6a in the present embodiment, the service evaluation part 62 compares the interpretation result data representing the performance state of the IT resources 2b to 2e required in the progress state with respect to the service users with the performance data representing the performance state of the IT resources 2b to 2e in the period during which the services S are provided to the service users. The service evaluation part 62 generates performance improvement data representing improvement points regarding the performance of the services S used by the service users. Consequently, the service operator can obtain improvement points regarding the performance of the services S from the performance improvement data generated by the service evaluation part 62. Therefore, the service operator can suggest, for example, improvement points regarding the performance of the services S, to the service provider providing the services S using the IT resources 2b to 2e.

### Embodiment 3

In Embodiment 2, an example has been described in which the service evaluation part generates improvement data, based on the contract data representing a contract content between the service operator and the service provider. In contrast, in Embodiment 3, an example will be described in which the service evaluation part generates improvement data based on schedule period data representing the schedule period of service users.

### (Configuration of an IT System)

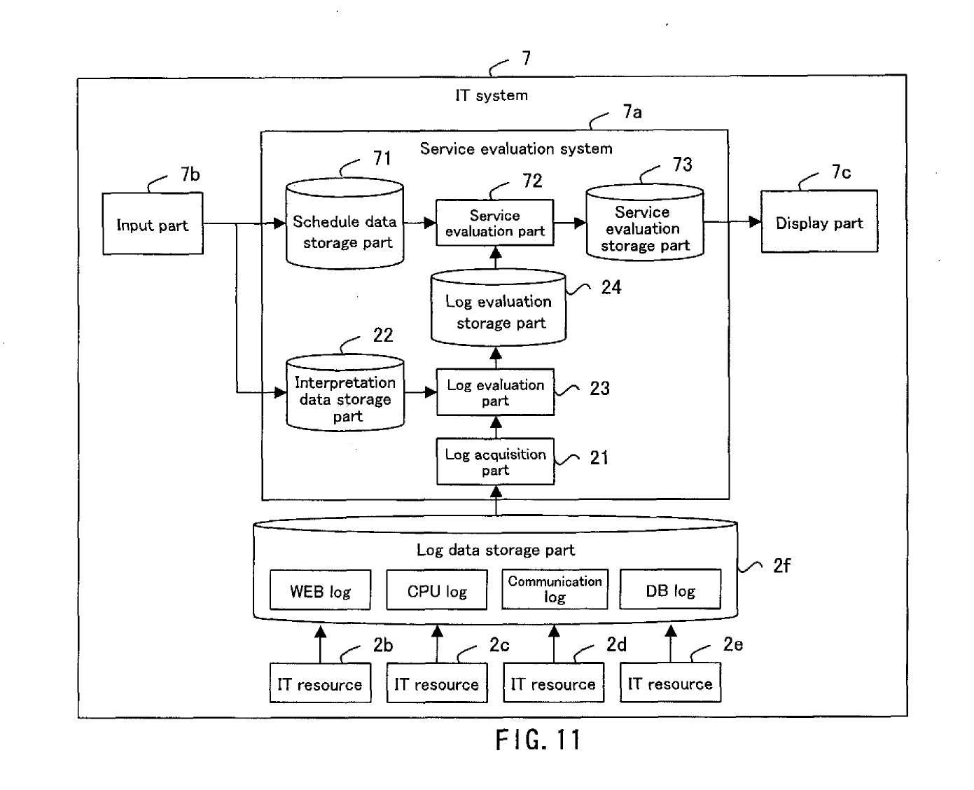

FIG. 11 is a block diagram showing a schematic configuration of an a system 7 according to the present embodiment. More specifically, the IT system 7 according to the present embodiment includes a service evaluation system 7a, an input part 7b, and a display part 7c in place of the service evaluation system 6a, the input part 6b, and the display part 6c shown in FIG. 8. In FIG. 11, components having the same functions as those of the components in FIG. 8 are denoted with the same reference numerals as those therein, and the detailed description thereof will be omitted.

The service evaluation system 7a evaluates the services S used by service users. The service evaluation system 7a will be described in detail.

The input part 7b has a function of enabling a service operator to input the schedule of the service users, in place of the function of the input part 6b in FIG. 8. The schedule of the service users may be input through the operator terminal 3 in place of the input part 7b. The schedule input by the service operator is stored in a schedule data storage part 71 described later.

The display part 7c is composed of a liquid crystal display, an organic EL display, a plasma display, a CRT display, or the like in the same way as in the display part 6c in FIG. 8.

### (Configuration of a Service Evaluation System)

The service evaluation system 7a includes a schedule data storage part 71 in place of the contract data storage part 61 shown in FIG. 8. Furthermore, the service evaluation system 7a includes a service evaluation part 72 and a service evaluation storage part 73 in place of the service evaluation part 62 and the service evaluation storage part 63 shown in FIG. 8. The service evaluation system 7s can also be constructed on a computer such as a personal computer or a server, instead of the deployment server 12, in the same way as in the service evaluation system 6a. Furthermore, the schedule data storage part 71, the service evaluation part 72, and the service evaluation storage part 73 constituting the service evaluation system 7a may be configured in one apparatus in the mass, or may be configured so as to be distributed in a plurality of apparatuses.

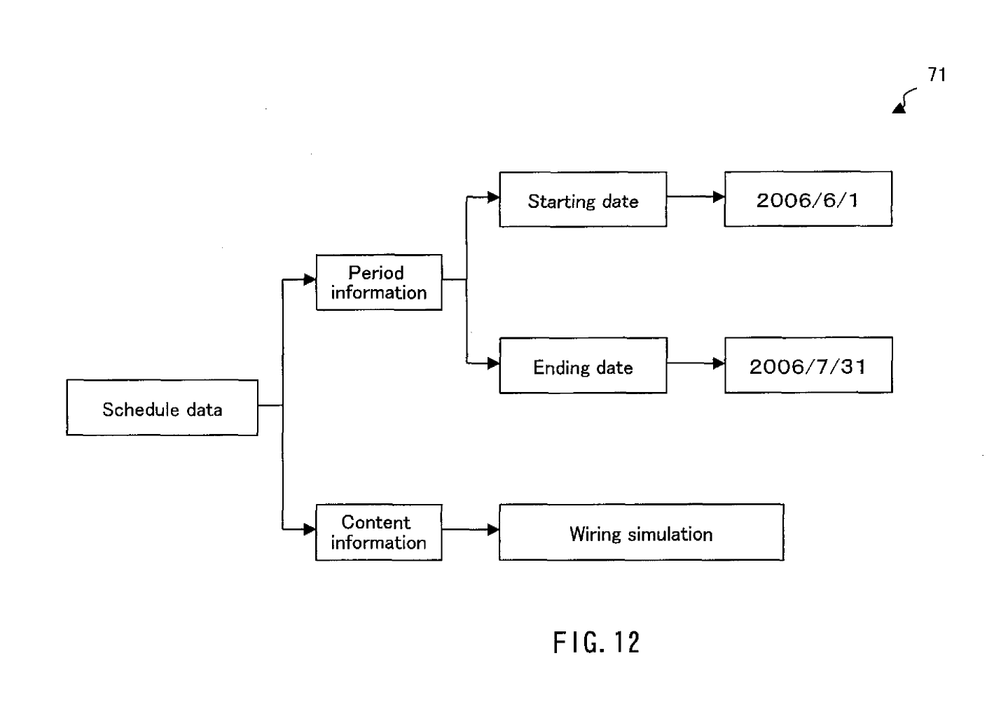

The schedule data storage part (period data storage part) 71 stores schedule data containing schedule period data representing the schedule period of the service users. FIG. 12 shows an example of a data structure of schedule data stored in the schedule data storage part 71. In the schema shown in FIG. 12, “schedule data” is associated with “period information” and “content information”.

The “period information” (schedule period data) is associated with data representing “2006/6/1” as a “starting date” and data representing “2006/7/31” as an “ending date”. The “content information” is associated with data representing a “wiring simulation”. More specifically, the example shown in FIG. 12 shows that the schedule of the service users during a period from Jun. 1, 2006 to Jul. 31, 2006 is a “wiring simulation”. In the present embodiment, the “wiring simulation” is assumed to be a simulation performed in a step (later period) of the “large-scale simulation” in the CAD project.

The service evaluation part 72 compares the evaluation result data stored in the log evaluation storage part 24 with the schedule data stored in the schedule data storage part 71 to generate improvement data (period improvement data) representing improvement points of the services S. The service evaluation part 72 outputs the generated period improvement data to the service evaluation storage part 73.

Specifically, the service evaluation part 72 extracts an “evaluation time” and “period information” in the evaluation result data stored in the log evaluation storage part 24. In the present embodiment, the service evaluation part 72 extracts the evaluation time “2006/7/31, 10:00:00” and the period information “intermediate period”. Furthermore, the service evaluation part 72 extracts the “period information” in the schedule period data stored in the schedule data storage part 71. In the present embodiment, the service evaluation part 72 extracts the starting date “2006/6/1” and the ending date “2006/7/31”.

The service evaluation part 72 compares the evaluation time “2006/7/31, 10:00:00” in the evaluation result data and the period information “intermediate period” with the starting date “2006/6/1” and the ending date “2006/7/31” in the schedule period data. As a result of the comparison, the service evaluation part 72 determines that the progress of a CAD project performed by the service users is still in a “large-scale simulation”, irrespective of the ending date (final date: Jul. 31, 2006) of the schedule period of the “wiring simulation” of the service users. More specifically, the service evaluation part 72 determines that the schedule period of the CAD project performed by the service users is delayed. As a result of the determination, the service evaluation part 72 generates, for example, period improvement data representing “it is necessary to extend the lending period of the IT resources”.

The service evaluation storage part 73 stores period improvement data representing improvement points of the services S generated by the service evaluation part 72. The service evaluation storage part 73 stores, for example, period improvement data representing “it is necessary to extend the lending period of the IT resources” generated by the service evaluation part 72.

The period improvement data stored in the service evaluation storage part 73 is output to the display part 7c based on an instruction from the display part 7c. The display part 7c displays the output period improvement data. More specifically, the display part 7c displays “it is necessary to extend the lending period of the IT resources”. As a result of this, the service operator can obtain improvement points of the services S based on the period improvement data displayed on the display part 7c.

Specifically, for example, in the case where the display part 7c displays, for example, “it is necessary to extend the lending period of the IT resources”, the service operator can obtain improvement points of the services S displayed on the display part 7c. Therefore, the service operator can suggest, to the service provider, for example, “it is better to extend the lending period of the IT resources”. Furthermore, for example, in the case where the display part 7c displays “it is necessary to extend the lending period of the IT resources for 20 days”, the service operator can obtain improvement points of the services S displayed on the display part 7c. Therefore, the service operator can specifically suggest, to the service provider, “it is better to extend the lending period of the IT resources for 20 days”.

The service evaluation system 7a can also be realized by installing a program in any computer such as a personal computer. More specifically, the service evaluation part 72 is embodied when a CPU of the computer is operated in accordance with a program realizing the function thereof. Thus, a program for realizing the function of the service evaluation part 72 and a recording medium storing the program are also included in one embodiment of the present invention. Furthermore, the contract data storage part 71 and the service evaluation storage part 73 are embodied by a storage apparatus contained in the computer or a storage apparatus accessible from the computer.

In the present embodiment, although an example has been described in which the schedule data stored in the schedule data storage part 71 is schedule data in the CAD project, the present invention is not limited thereto. Needless to say, the present invention can be applied to the case of schedule data in sales management, production management, and learning management.

As described above, according to the service evaluation system 7a in the present embodiment, the service evaluation part 72 compares the interpretation result data representing the progress state with respect to the service users with the schedule period data representing the schedule period of the service users. The service evaluation part 72 generates period improvement data representing improvement points regarding the period of the services S used by the service users. Consequently, the service operator can obtain improvement points regarding the period of the service S from the period improvement data generated by the service evaluation part 72. Therefore, the service operator can suggest, to the service provider that provides the services S using the IT resources 2b to 2e, for example, improvement points regarding the period of the services S.

### Embodiment 4

In Embodiment 3, an example has been described in which interpretation condition data stored in the interpretation data storage part is input through the input part. In contrast, in Embodiment 4, an example will be described in which the interpretation condition data stored in the interpretation data storage part is generated by the interpretation condition data generation part.

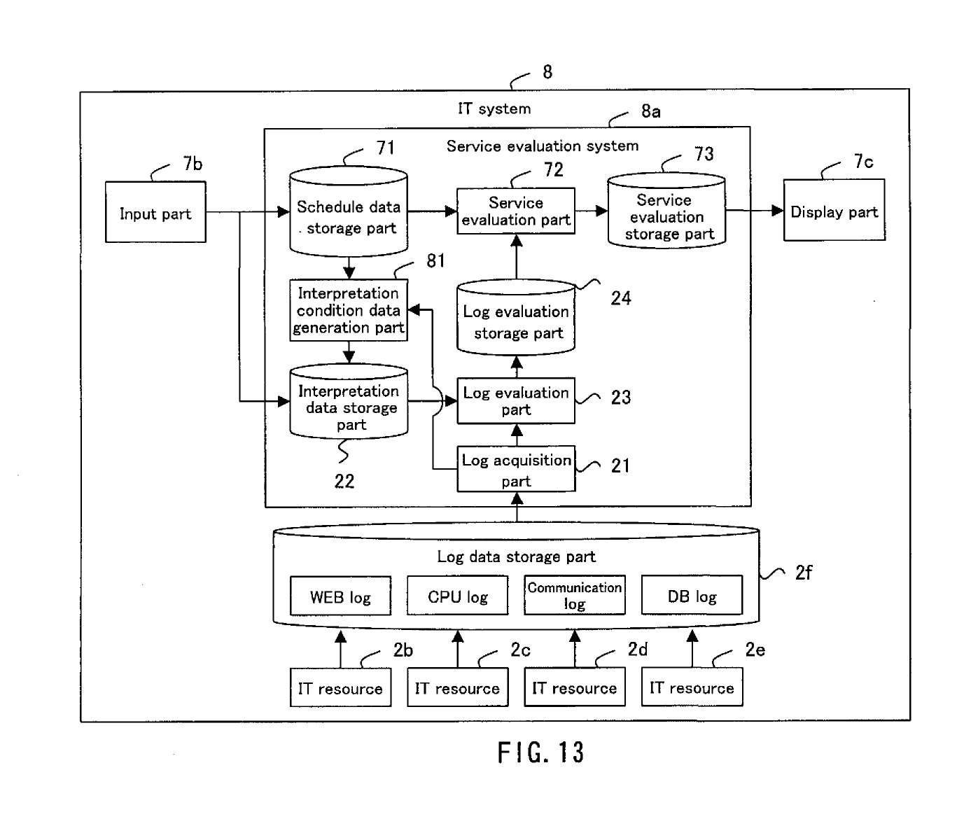

FIG. 13 is a block diagram showing a schematic configuration of an IT system 8 according to the present embodiment. More specifically, the IT system 8 according to the present embodiment includes a service evaluation system 8a in place of the service evaluation system 7a shown in FIG. 11. In FIG. 13, components having the same functions as those of the components in FIG. 11 are denoted with the same reference numerals as those therein, and the detailed description thereof will be omitted.

In the present embodiment, as an example, the case will be described in which a CAD project performed by the service users, using the IT resource (CAD server) in the services S provided by the service provider, has been completed.

The service evaluation system 8a includes an interpretation condition data generation part 81 in addition to the service evaluation system 7a shown in FIG. 11. The service evaluation system 8a can also be constructed on, for example, a computer such as a personal computer or a server, instead of the deployment server 12, in the same way as in the service evaluation system 7a. Furthermore, the interpretation condition data generation part 81 constituting the service evaluation system 8a may be configured in one apparatus, or may be configured so as to be distributed in a plurality of apparatuses.

The interpretation condition data generation part 81 generates interpretation condition data, based on the schedule period data stored in the schedule data storage part 71 and the log data acquired by the log acquisition part 21. The interpretation condition data generation part 81 outputs the generated interpretation condition data to the interpretation data storage part 22.

The interpretation condition data generation part 81 generates interpretation condition data, using a term frequency inverse document frequency (TFIDF), for example, when the log data acquired by the log acquisition part 21 is so-called character string type log data such as a Web log and a DB log. The TFIDF method is a method for weighing a keyword based on the appearance frequency of a word.

Specifically, the interpretation condition data generation part 81 extracts schedule period data stored in the schedule data storage part 71. In the example shown in FIG. 12, the interpretation condition data generation part 81 extracts a starting date “2006/6/1” and an ending date “2006/7/31”. The interpretation condition data generation part 81 divides the log data of a Web log and a DB log acquired by the log acquisition part 21 in a period represented by the schedule period data. In the example shown in FIG. 12, since the schedule period data represents the starting date “2006/6/1” and the ending date “2006/7131”. Therefore, the log data of the Web log and the DB log is divided into log data in a period from Jun. 1, 2006 to Jul. 31, 2006. The interpretation condition data generation part 81 extracts a word to be a feature from the divided log data, using the TFIDF method. The interpretation condition data generation part 81 sets the extracted word to be interpretation condition data. In the present embodiment, it is assumed that the interpretation condition data generation part 81 has extracted “http://cad.com/sim” representing a URL from the log data of the Web log.

In the above, although an example has been described in which the interpretation condition data generation part 81 extracts a word to be a feature from the log data of the Web log and the DB log, using the TFIDF method, the present invention is not limited thereto. For example, a word to be a feature may be extracted from the log data of the Web log and the DB log, using known text mining such as morpheme analysis, N-gram analysis, or keyword analysis.

Furthermore, when the log data acquired by the log acquisition part 21 is so-called numerical value type log data such as a CPU log or a communication log, the interpretation condition data generation part 81 calculates an average fluctuation over an entire period with respect to each item of the numerical value type log data. The interpretation condition data generation part 81 sets an item, in which the difference between the calculated average fluctuation and the time-series data is largest, to be interpretation condition data.

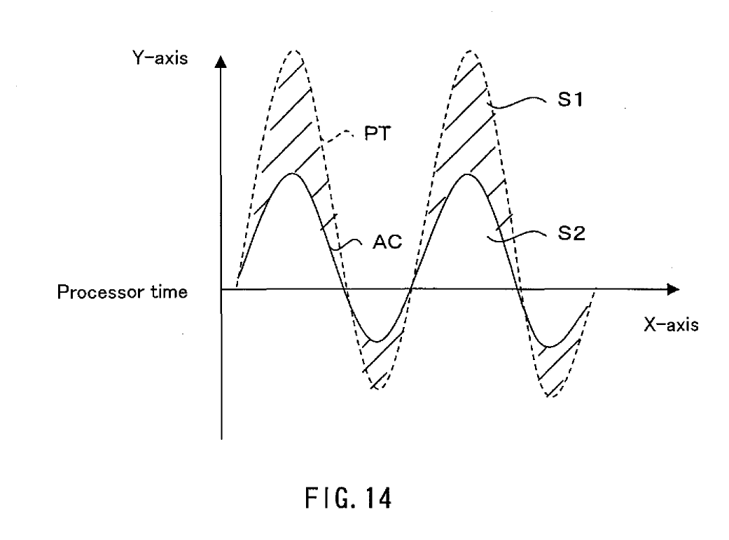

FIG. 14 is a conceptual diagram showing an example of average fluctuation data AC and time-series data PT in an item of a processor time of the CPU log. The interpretation condition data generation part 81 calculates average fluctuation data AC representing a 24-hour average fluctuation over an entire period in the processor time of the CPU log, as shown in FIG. 14. The time-series data PT represents a time-series actually measured value in the processor time of the CPU log. The time-series data PT is data that has been subjected to normalization so as to have an average of 0 and a variance of 1 by the interpretation condition data generation part 81.

Herein, as shown in FIG. 14, an area (hereinafter, referred to as a “differential area”) between a curve drawn by the time-series data PT and a curve drawn by the average fluctuation data AC is assumed to be S1. Furthermore, an area (hereinafter, referred to as an “average fluctuation area”) between a curve drawn by the average fluctuation data AC and an X-axis is assumed to be S2. The interpretation condition data generation part 81 calculates an area ratio between the differential area S1 and the average fluctuation area S2. More specifically, the interpretation condition data generation part 81 calculates S1÷S2 as an area ratio. The area ratio is 0 or more. As the area ratio is smaller, the curve drawn by the time-series data PT is more matched with the curve drawn by the average fluctuation data AC.

The interpretation condition data generation part 81 performs the above calculation of an area ratio for each item of the CPU log. The interpretation condition data generation part 81 extracts an item, in which the area ratio is largest among all the items, to be interpretation condition data. More specifically, as the area ratio is larger, the difference from an average fluctuation is larger. In the present embodiment, it is assumed that the interpretation condition data generation part 81 extracts an item of the “processor time” from each item of the CPU log.

In the above, although an example has been described in which the interpretation condition data generation part 81 calculates an average fluctuation over an entire period with respect to each item of the log data, and sets an item, in which the difference between the calculated average fluctuation and the time-series data is largest, to be interpretation condition data, the present invention is not limited thereto. For example, the log data may be subjected to frequency analysis to calculate an average frequency distribution, and an item, in which the difference between the calculated frequency distribution and the time-series data is largest, to be interpretation condition data. More specifically, interpretation condition data can be generated by any method other than the above method, using a known technique capable of checking the difference (alienation) from a value represented on average by various numerical feature values that can be acquired from the log data.

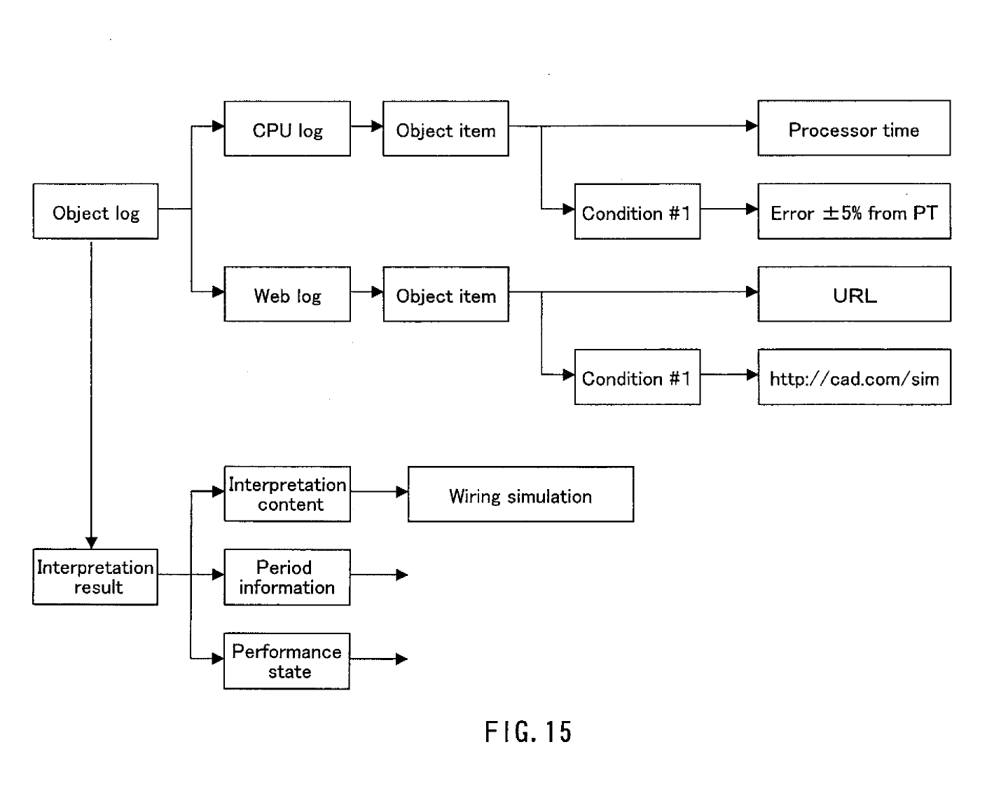

FIG. 15 is a diagram showing an example of interpretation condition data generated by the interpretation condition data generation part 81. The schema shown in FIG. 15 contains data representing an “object log” as interpretation condition data and data representing an “interpretation result” as interpretation result data.

The data representing the “object log” is associated with data representing a “CPU log” and data representing a “Web log”. The data representing the “CPU log” is associated with data representing a “processor time” as an “object item”. Furthermore, the data representing the “CPU log” is associated with data representing an “error ±5% from PT” as “condition #1” of the “object item”. More specifically, in the case where the time-series data PT represents “30 minutes”, the time-series data PT refers to “28.5 minutes to 31.5 minutes” due to the “error ±5% from PT”. The error range is input by the service operator using the input part 7b. The data representing the “Web log” is associated with data representing a “URL” as an “object item”. Furthermore, the data representing the “Web log” is associated with data representing “http://cad.com/sim” as “condition #1” of the “object item”.

The “interpretation result” is allowed to correspond to the data representing the “object log” as interpretation condition data. The “interpretation result” is associated with an “interpretation content”, “period information”, and a “performance state”. The “interpretation content” is associated with data representing a “wiring simulation”. The “period information” and the “performance state” are blank. Therefore, the “period information” and the “performance state” are input by the service operator through the input part 7b in the same way as in Embodiment 3.

The service evaluation system 8a is also realized by installing a program in any computer such as a personal computer. More specifically, the interpretation condition data generation part 81 is embodied when a CPU of the computer is operated in accordance with a program realizing the function thereof. Thus, a program for realizing the function of the interpretation condition data generation part 81 or a recording medium storing the program are also included in one embodiment of the present invention.

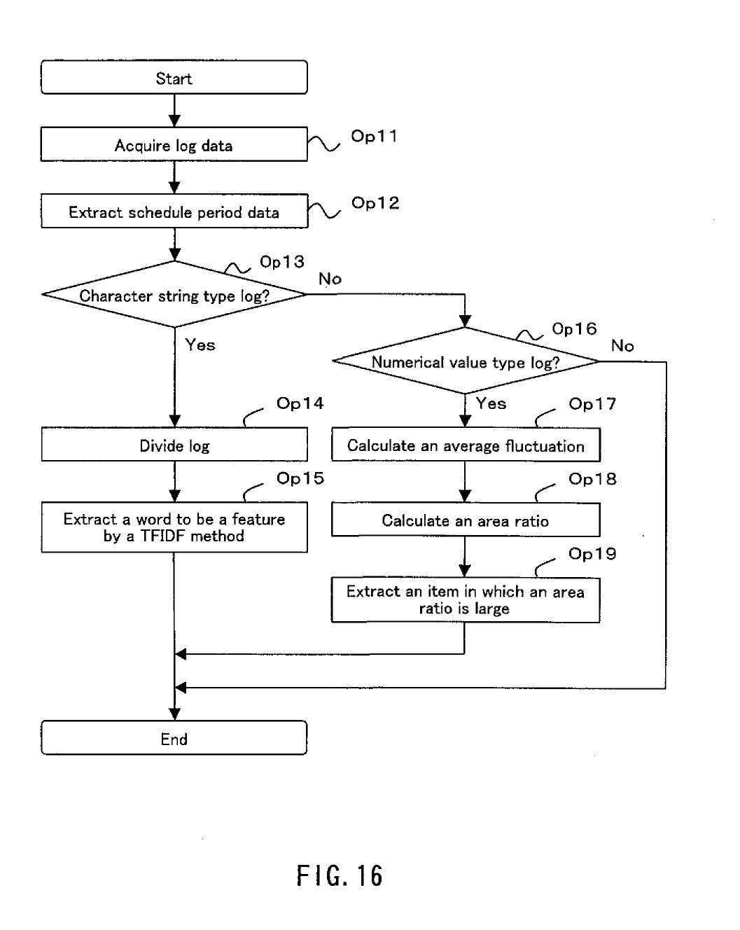

Next, the processing to the interpretation condition data generation part 81 in the service evaluation system 8a according to the above configuration will be described with reference to FIG. 16.

FIG. 16 is a flowchart showing an outline of the processing of the interpretation condition data generation part 81. More specifically, as shown in FIG. 16, the interpretation condition data generation part 81 acquires log data acquired by the log acquisition part 21 from the log data storage part 2f (Op 11). Then, the interpretation condition data generation part 81 extracts schedule period data stored in the schedule data storage part 71 (Op 12).

If the interpretation condition data generation part 81 determines that the log data acquired in Op 11 is so-called character string type log data such as a Web log and a DB log (YES in Op 13), the interpretation condition data generation part 81 divides the log data acquired in Op 11 in a period represented by the schedule period data (Op 14). Then, the interpretation condition data generation part 81 extracts a word to be a feature from the divided log data using the TFIDF method (Op 15). The interpretation condition data generation part 81 sets the extracted word to be interpretation condition data.

On the other hand, when the interpretation condition data generation part 81 determines that the log data acquired in Op 11 is not so-called character string type log data (NO in Op 13), the process proceeds to Op 16, and for example, the interpretation condition data generation part 81 determines whether or not the log data acquired in Op 11 is so-called numerical value type log data such as a CPU log and a communication log.

When the interpretation condition data generation part 81 determines that the log data acquired in Op 11 is so-called numerical value type log data (YES in Op 16), the interpretation condition data generation part 81 calculates an average fluctuation over an entire period with respect to each item of the log data (Op 17). The interpretation condition data generation part 81 calculates an area ratio between a differential area 51 and an average fluctuation area S2 with respect to each item of the log data (Op 18). Then, the interpretation condition data generation part 81 extracts an item, in which an area ratio is largest among all the items, as interpretation condition data (Op 19).

On the other hand, when the interpretation condition data generation part 81 determines that the log data acquired in Op 11 is not so-called numerical value type log data (NO in Op 16), the process is completed.

As described above, according to the service evaluation system 8a in the present embodiment, the interpretation condition data generation part 81 generates interpretation condition data based on the schedule period data and the log data. Since the interpretation condition data generation part 81 generates interpretation condition data, the time and labor of the service operator can be reduced, compared with Embodiments 1 to 3 in which the service operator generates interpretation condition data using the input part.

In Embodiments 1 to 4, although the service evaluation system in an IT system of an IDC has been described, the present invention is not limited thereto. More specifically the present invention can be applied to the overall system that provides services to service users using IT resources operated by the service operator, without being limited to an IDC.

As described above, the present invention is useful as a service evaluation system, a service evaluation method, and a service evaluation program capable of obtaining improvement points of services used by service users in a service operator.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A service evaluation system that evaluates a service in an IT system providing the service to a service user using an IT resource operated by a service operator, comprising:
a log acquisition part that acquires log data of the IT resource from a log data storage part storing the log data;
an interpretation data storage part that stores interpretation condition data representing a standard for interpreting the log data and interpretation result data representing a use state of the service by the service user, associated with the interpretation condition data; and
a log evaluation part that extracts and outputs the interpretation result data stored in the interpretation data storage part, when the log data acquired by the log acquisition part satisfies the standard represented by the interpretation condition data.

2. The service evaluation system according to claim 1, wherein the interpretation result data represents a progress state with respect to the service user in the service used by the service user, and
the service evaluation system further comprises:
a period data storage part that stores provision period data representing a period during which the service is provided to the service user or schedule period data representing a schedule period of the service user; and
a service evaluation part that compares the interpretation result data extracted by the log evaluation part with the provision period data or the schedule period data stored in the period data storage part to generate period improvement data representing an improvement point regarding the period of the service used by the service user.

3. The service evaluation system according to claim 2, wherein the interpretation result data further represents a performance state of the IT resource required in a progress state with respect to the service user,
the service evaluation system further comprises a performance data storage part that stores performance data representing a performance state of the IT resource in a period during which the service is provided to the service user, and
the service evaluation part compares the interpretation result data extracted by the log extraction part with the performance data stored in the performance data storage part to further generate performance improvement data representing an improvement point regarding performance of the service used by the service user.

4. The service evaluation system according to claim 2, further comprising an interpretation condition data generation part that generates the interpretation condition data, based on the schedule period data stored in the period data storage part and the log data acquired by the log acquisition part.

5. The service evaluation system according to claim 1, wherein the log data represents an access state to the service by the service user and an operation state of the IT resource, and
the interpretation condition data represents a standard for interpreting the log data on a basis of the access state and the operation state.

6. A service evaluation method for evaluating a service in an IT system providing the service to a service user using an IT resource operated by a service operator,
wherein in a computer which is accessible to an interpretation data storage part that stores interpretation condition data representing a standard for interpreting log data of the IT resource and interpretation result data representing a use state of the service by the service user, associated with the interpretation condition data,
the method comprises:
acquiring, by the computer, the log data from a log data storage part storing the log data; and
extracting, by the computer, the interpretation result data stored in the interpretation data storage part, in a case where the log data acquired by the computer satisfies the standard represented by the interpretation condition data.

7. A recording medium storing a service evaluation program that causes a computer to execute processing for evaluating a service in an IT system providing the service to a service user using an IT resource operated by a service operator,
wherein in the computer which is accessible to an interpretation data storage part that stores interpretation condition data representing a standard for interpreting log data of the IT resource and interpretation result data representing a use state of the service by the service user, associated with the interpretation condition data,
the program causes the computer to execute:
acquiring the log data of the IT resource from a log data storage part storing the log data; and
extracting the interpretation result data stored in the interpretation data storage part, in a case where the acquired log data satisfies the standard represented by the interpretation condition data.
